(19) United States
(12) Patent Application Publication
(10) Pub. No.: US 2026/0194997 A1
(43) Pub. Date: Jul. 9, 2026

(54) TOUCH SENSING DEVICE WITH ADJUSTABLE TOUCH CONTROL PARAMETERS

(71) Applicant: PIXART IMAGING INC., Hsin-Chu County (TW)

(72) Inventors: Tse-Chung SU, Hsin-Chu County (TW); Chi-Chieh LIAO, Hsin-Chu County (TW)

(21) Appl. No.: 19/012,856

(22) Filed: Jan. 8, 2025

(51) Int. Cl. G06F 3/038; G06F 3/0354

(52) U.S. Cl. CPC G06F 3/0383; G06F 3/03547; G06F 3/044

(57) ABSTRACT

There is provided a touch sensing device including a touchpad, a memory and a processor. The touchpad is used to output a sensing matrix having multiple sensing values. The memory is recorded with operation parameters associated with the touchpad. The processor is used to update the operation parameters according to the operation habit and features on the touchpad within a statistical interval for a number of times of operations of the touchpad to determine a first zone and a second zone, having a respective control parameter, corresponding to the touchpad.

### FIELD OF THE DISCLOSURE

This disclosure generally relates to a touch sensing device and, more particularly, to a touch sensing device and an operating method thereof that adjust/update a threshold for distinguishing a finger and a palm, a threshold for identifying a touch force and a threshold for identifying an object shape according to the usage habit and the operation feature of a user.

### BACKGROUND OF THE DISCLOSURE

The capacitive touchpad nowadays is arranged with a single set of fixed identification parameters after shipment for eliminating an operation caused by a palm accidently in contact with the touchpad. However, according to the usage habit of different users, it is possible that the capacitive touchpad mistakenly identifies a palm as a finger or it is unable to identify a finger due to a small touch force thereon.

Therefore, a touchpad that is adaptable to different usage habits and finger features of different users is required.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a touch sensing device and an operating method thereof that divide a touchpad into a hot zone and a cold zone according to the using frequency of a user and that use a smart parameter in the cold zone to avoid the mistaken touch of a palm. The conception is that the possibility of a palm appearing on the cold zone is generally higher than on the hot zone, and thus a more sensitive parameter is used in the cold zone to prevent the palm operation.

The present disclosure further provides a touch sensing device and an operating method thereof that adjust/update a touch identification threshold according to a finger sensing value of a user to avoid the finger appearance unable to be detected. The conception is that when a finger area is smaller, a smaller touch identification threshold should be used to increase the possibility of detecting a finger touch.

The present disclosure further provides a touch sensing device and an operating method thereof that adjust/update a palm/finger recognition parameter according to a finger length/width ratio of a user to avoid a mistaken touch of a palm. The conception is that when a user is used to operate with his/her finger tip, a detected finger length/width ratio is closer to a circle; whereas, when a user is used to operate with his/her finger belly, the detected finger length/width ratio is closer to an ellipse.

The present disclosure provides a touch sensing device including a touchpad, a memory and a processor. The touchpad is configured to output a sensing matrix comprising multiple sensing values. The memory is configured to record a first zone and a second zone corresponding to the touchpad, a first parameter corresponding to the first zone and a second parameter corresponding to the second zone, wherein the first parameter is a fixed parameter and the second parameter is a variable parameter. The processor is configured to determine to use the first parameter or the second parameter according to whether a position of a first contact, which is detected during each operation of the touchpad, is in the first zone or the second zone.

The present disclosure provides a touch sensing device including a touchpad, a memory and a processor. The touchpad is configured to output a sensing matrix comprising multiple sensing values. The memory is configured to record a first zone and a second zone corresponding to the touchpad. The processor is configured to define the first zone and the second zone according to multiple sets of sensing values associated with multiple sensing matrixes received in a predetermined time interval.

The present disclosure provides a touch sensing device including a touchpad, a memory and a processor. The touchpad is configured to output a sensing matrix comprising multiple sensing values. The memory is configured to record at least one of a sensing value parameter, a length ratio parameter and a size parameter for identifying an object state. The processor is configured to update at least one of the sensing value parameter, the length ratio parameter and the size parameter according to multiple sets of sensing values associated with multiple sensing matrixes received in a predetermined time interval.

The present disclosure further provides a touch sensing device including a touchpad, a memory and a processor. The touchpad is configured to output a sensing matrix comprising multiple sensing values. The memory is configured to record an identification parameter for identifying whether an object touch occurs. The processor is configured to record a maximum sensing value of each finger touch within a statistical interval during which a number of times of operations of the touchpad reaches a predetermined times, and adjust the identification parameter according to multiple maximum sensing values within the statistical interval.

The present disclosure further provides a touch sensing device including a touchpad, a memory and a processor. The touchpad is configured to output a sensing matrix comprising multiple sensing values. The memory is configured to record a ratio parameter for identifying whether a finger touch occurs. The processor is configured to record a sensing value distribution of each finger touch within a statistical interval during which a number of times of operations of the touchpad reaches a predetermined times, calculate multiple length ratios of long-axis and short-axis of multiple sensing value distributions of multiple finger touches during the statistical interval, and update the ratio parameter according to the multiple length ratios of long-axis and short-axis.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic diagram of a computer system including a touch sensing device according to one embodiment of the present disclosure.

FIG. 2 is a schematic diagram of determining a hot zone and a cold zone of a touch sensing device according to a first embodiment of the present disclosure.

FIG. 3 is a flow chart of an operating method of updating a finger recognition parameter of a touch sensing device according to a first embodiment of the present disclosure.

FIG. 4 is schematic diagram of a sensing matrix including multiple sensing values outputted by a touch sensing device according to one embodiment of the present disclosure.

FIG. 5 is a schematic diagram of an operating method of updating a touch identification parameter of a touch sensing device according to a second embodiment of the present disclosure.

FIG. 6 is a schematic diagram of selecting a standard deviation in an operating method of a touch sensing device according to one embodiment of the present disclosure.

FIG. 7 is a flow chart of an operating method of updating a finger recognition parameter of a touch sensing device according to a third embodiment of the present disclosure.

FIG. 8 is a schematic diagram of calculating a long-axis and a short-axis of a finger image in an operating method of updating a finger recognition parameter of a touch sensing device according to a third embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a capacitive touch sensing device and an operating method thereof that adjust/update touch control parameters according to the usage habit and the finger feature of a user. The touch control parameters include a parameter for distinguishing a finger and a palm (e.g., herein referred to a finger recognition parameter which may be a threshold indicated by a pixel number/area or shape) and a parameter for identifying whether an object appears or not (e.g., herein referred to a touch identification parameter which may be a threshold indicated by a sensing value of a touchpad).

The touch control parameters of the present disclosure are provided for a processor to identify an object state, e.g., including whether a finger touch or a palm touch occurs or not. Upon identifying an object triggering the finger touch, the processor sends a signal (e.g., including a tip bit=1 and a confidence bit=1, but not limited to) to the operation system of a computer system such that the computer system performs corresponding controls. Upon identifying an object triggering the palm touch, the processor sends a signal (e.g., including a tip bit=1 and a confidence bit=0, but not limited to) to the operation system of a computer system such that the computer system performs corresponding controls.

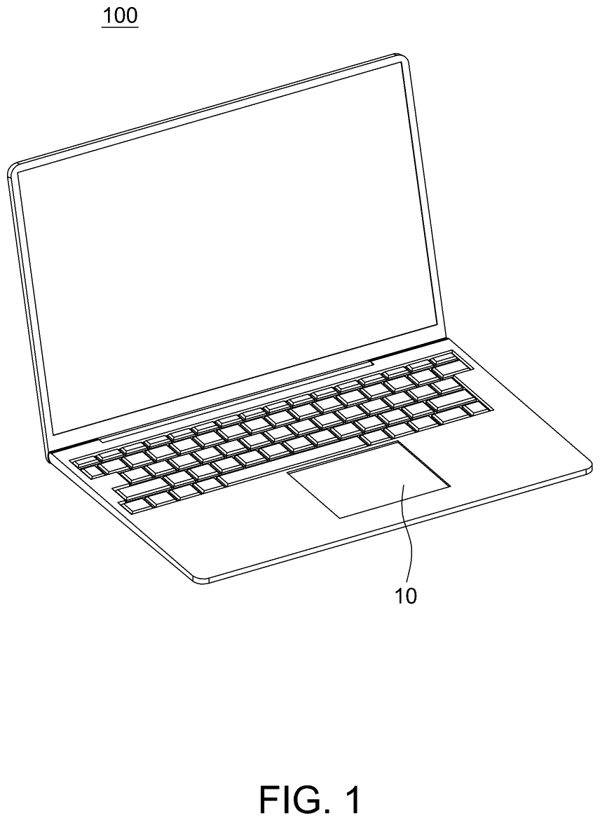

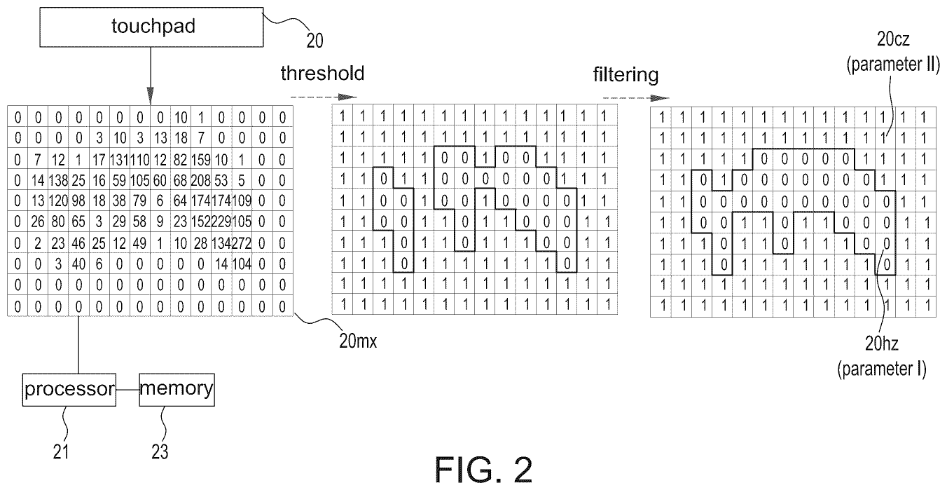

Please refer to FIGS. 1 and 2, FIG. 1 is a schematic diagram of a computer system 100 including a touch sensing device 10 according to one embodiment of the present disclosure; and FIG. 2 is a schematic diagram of determining a hot zone 20hz and a cold zone 20cz of a touch sensing device 10 according to a first embodiment of the present disclosure. In the present disclosure, different finger recognition parameters (and/or touch identification parameter) are used respectively corresponding to the hot zone 20hz and the cold zone 20cz to eliminate the mistaken touch of a palm on the cold zone 20cz (and/or unable to identify an object touch).

In FIG. 2, the hot zone 20hz is shown to be located close to a central area of the touchpad 20 and the cold zone 20cz is shown to be located at the peripheral area of the touchpad 20. It is appreciated that a distribution of the hot zone 20hz and the cold zone 20cz is determined according to the user habit and is not limited to that shown in FIG. 2.

Please refer to FIGS. 1 and 2 continuously, the touch sensing device 10 includes a touchpad 20, a processor 21 and a memory 23. FIG. 2 further shows a touch statistic matrix 20mx of multiple pixel regions (e.g., each including multiple pixels) outputted by the touchpad 20, wherein each value in the touch statistic matrix 20mx indicates a number of times that each pixel region detects an object (e.g., referred to touch information, including a touch position, touch sensing values and a number of touches of an object) within a statistical interval (e.g., predetermined time interval), which is determined before shipment or by a user after shipment. In one aspect, the processor 21 and the memory 23 are arranged in a control chip of the touchpad 20.

In the present disclosure, the touchpad 20 is illustrated using a capacitive touchpad as an example. The touchpad 20 outputs capacitance sensing values for identifying a touch of an object by the processor 21. The object includes a finger (e.g., an object size appearing on the touchpad 20 being smaller than a finger recognition parameter and suitable for the touch control) and a palm (e.g., an object size appearing on the touchpad 20 being larger than the finger recognition parameter and not suitable for the touch control). More specifically, the finger and the palm include any object that can be sensed by the touchpad 20, but are not limited to a human finger and palm.

The memory 23 includes a volatile memory and/or a non-volatile memory, which records a first zone (e.g., a range of the hot zone 20hz) and a second zone (e.g., a range of the cold zone 20cz) corresponding to the touchpad 20, a first parameter (e.g., shown as parameter I) corresponding to the first zone 20hz and a second parameter (e.g., shown as parameter II) corresponding to the second zone 20cz. In the first embodiment, the method of determining each zone and corresponding parameters is described hereinafter.

The first parameter is a fixed parameter, e.g., a first default value determined before shipment; and the second parameter is a variable parameter, e.g., obtained by continuously updating a second default value (identical to or different from the first default value) according to user operations. For example, the first parameter and the second parameter are pixel sizes (e.g., size parameter) for distinguishing a finger and a palm. In one aspect, the second parameter, after being updated, has a value smaller than a value of the first parameter such that a palm may be detected easier in the cold zone 20cz.

The processor 21 is, for example, an application specific integrated circuit (ASIC), a field programmable gate array (FPGA) or a micro controller unit (MCU) that implements functions thereof using software, firmware and/or hardware. In the first embodiment, the processor 21 uses the first parameter upon detecting a position of a first contact, which is detected during each operation of the touchpad 20, in the first zone 20hz, wherein there is no object appearing on the touchpad 20 within a predetermined time interval before the first contact; and the processor 21 uses the second parameter upon detecting a position of the first contact in the second zone 20cz. In one aspect, if a user continuously operates in the first zone 20hz and then enters the second zone 20cz (without leaving the touchpad 20), the first parameter is used after the finger enters the second zone 20cz. On the contrary, if a user continuously operates in the second zone 20cz and then enters the first zone 20hz (without leaving the touchpad 20), the second parameter is used after the finger enters the first zone 20hz.

When the touchpad 20 is operated to a predetermined times (or accumulated operation time reaching a predetermined time interval) as a statistical interval, the processor 21 identifies a region having a number of times of touching higher than a predetermined threshold as the first zone and identifies a region having a number of times of touching lower than the predetermined threshold as the second zone. At the next time that a number of times of operations of the touchpad 20 reaches the predetermined times (i.e. next statistical interval), the processor 21 uses the same way to determine a new first zone and a new second zone, i.e. updating. For example, a number of times of operations herein is referred to a number of times that the touchpad 20 detects a finger touch, a number of times that the touchpad 20 is activated or a number of times of valid data being recorded.

In one aspect, to reduce the calculation of the processor 21, the processor 21 firstly divides a sensing matrix outputted by the touchpad 20 into multiple pixel regions each having N×M pixels, e.g., a left diagram in FIG. 2 showing the sensing matrix being divided into 14×10 pixel regions and showing corresponding touch statistic matrix 20mx. N and M are positive integers and values thereof are determined according to the required resolution of the touchpad 20 without particular limitations.

In the predetermined times, the processor 21 counts a number of times of touching of each pixel region among the multiple pixel regions, e.g., the left diagram in FIG. 2 showing an accumulated number of times of touching (abbreviated as number of times of touching). In one aspect, the processor 21 identifies a pixel region having a sensing value larger than a touch identification parameter as a touch occurring, e.g., accumulated number of times being added by 1.

After the statistical interval, the processor 21 compares the number of times of touching of each pixel region with a predetermined threshold (e.g., 30 times, but not limited to) to identify whether each pixel region is belong to the first zone (e.g., regions indicated by “0” in a middle diagram in FIG. 2) or the second zone (e.g., regions indicated by “1” in the middle diagram in FIG. 2). It is appreciated that the first zone may be indicated by “1” or other values, and the second zone may be indicated by “0” or other values.

The predetermined threshold may be previously determined according to the required sensitivity without particular limitations.

In the first embodiment, the processor 21 defines a first zone 20hz and a second zone 20cz according to multiple sets of sensing values associated with multiple sensing matrixes received in the predetermined time interval from the touchpad 20. More specifically, the processor 21 determines whether multiple positions (e.g., pixel regions mentioned above) of the touchpad 20 detect an object touch according to the multiple sets of sensing values, and defines the first zone 20hz and the second zone 20cz according to touch information of every position (e.g., left diagram in FIG. 2) in the predetermined time interval.

Next, the processor 21 further receives one set of sensing values (e.g., in one sensing matrix) containing the touch information after the predetermined time interval, and identifies an object state in the first zone 20hz or the second zone 20cz according to the one set of sensing values. That is, the first parameter and the second parameter are used to identify the object state, and the first parameter is different from the second parameter.

In one aspect, the processor 21 further performs filtering (e.g., non-directional filtering or smooth filtering) on the multiple pixel regions containing the first zone and the second zone (e.g., the middle diagram in FIG. 2) to cause separated first zones to connect to each other, e.g., a right diagram in FIG. 2. In this way, a hot zone 20hz and a cold zone 20zx on the touchpad 20 are determined. It should be mentioned that it is not necessary to merge multiple separated hot zones to a single hot zone, and it is possible to contain multiple hot zones.

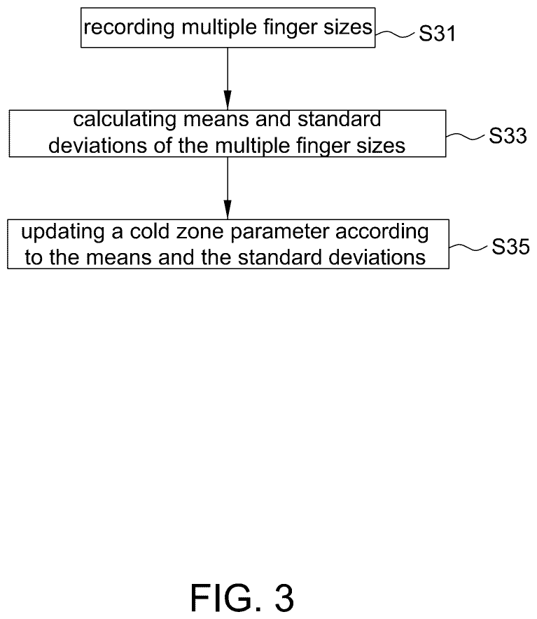

Please refer to FIG. 3, is a flow chart of an operating method of updating a finger recognition parameter of a touch sensing device 10 according to a first embodiment of the present disclosure. In one aspect, in the predetermined times, the processor 21 records multiple finger sizes appearing in the sensing matrix outputted by the touchpad 20, Step S31. It should be mentioned that the processor 21 is arranged not to record/process sizes of non-finger (i.e. the palm) to prevent from using unsuitable data to update the finger recognition parameter.

Step S33: Next, the processor 21 calculates a mean and a standard deviation of the multiple finger sizes.

Step S35: Finally, the processor 21 updates the second parameter according to the mean and the standard deviation (e.g., 2 or 3 times of standard deviation). For example, the processor 21 firstly calculates a target parameter=mean+K times of standard deviation. Then, the processor 21 uses IIR smoothing to calculate an updated second parameter=the target parameter×R+original second parameter×(1−R), wherein R is between 0 and 1 for determining the updating speed.

In the first embodiment, by continuously updating the second parameter (after each statistical interval), the hot zone 20hz is continuously updated to the most frequently used zone to effectively eliminate the mistaken touch of a palm in the cold zone 20cz.

The touch sensing device 10 of the second embodiment of the present disclosure adjusts an identification parameter, which may be indicated by a sensing value of the touchpad 20, for identifying whether an object touch occurs. The touch sensing device 10 of the second embodiment also includes the touchpad 20, the processor 21 and the memory 23 in FIG. 2, and the types thereof have been illustrated above only with different functions as described hereinafter.

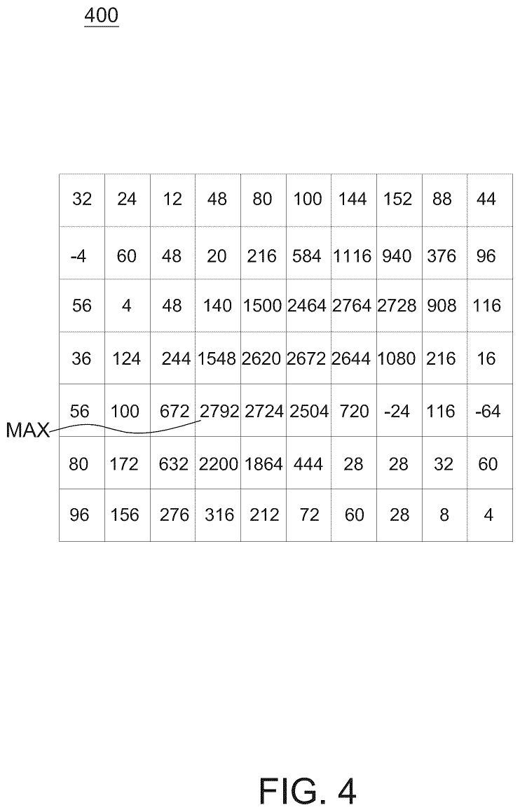

The touchpad 20 outputs a sensing matrix 400 including multiple sensing values, e.g., FIG. 4 showing each pixel having a sensing value. It is appreciated that a size and sensing values shown in the sensing matrix 400 in FIG. 4 are only intended to illustrate but not to limit the present disclosure. It is appreciated that when the touchpad 20 is a capacitive touchpad, the sensing values are capacitance sensing values. However, if the touchpad 20 is another type of touchpad, the sensing values are other corresponding sensing values, e.g., optical sensing values or resistance sensing values.

The memory 23 records an identification parameter for identifying whether an object touch occurs, e.g., the identification parameter being set as 100 in FIG. 4. When a sensing value of one pixel is larger than 100, an object touch is identified on the one pixel; whereas when a sensing value of one pixel is smaller than or equal to 100, no object touch is identified on the one pixel. The processor 21 further identifies multiple adjacent pixels respectively having a sensing value larger than 100 as an object, e.g., generating a tip bit=1. After the object is confirmed as a finger, a confidence bit=1 is generated, and after the object is confirmed as a palm, a confidence bit=0 is generated. In other words, the confidence bit is used to indicate whether an object is a finger, and a format of the confidence bit is not particularly limited.

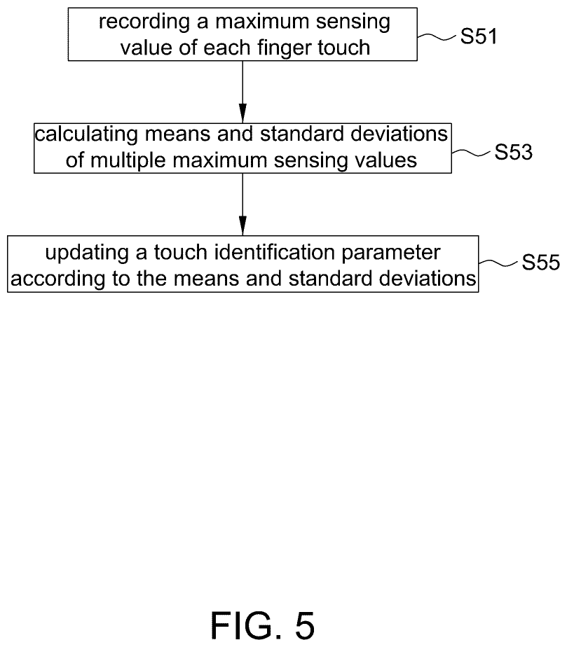

Please refer to FIG. 5, it is a schematic diagram of an operating method of updating a touch identification parameter of a touch sensing device 10 according to a second embodiment of the present disclosure. When the touchpad 20 is operated to a predetermined times (or accumulated operation time reaching a predetermined time interval) to determine a statistical interval, the processor 21 records a maximum sensing value of each finger touch in the memory 23 (Step S51), e.g., FIG. 4 showing MAX=2792 as the maximum sensing value. The processor 21 then adjusts the identification parameter (e.g., sensing value parameter) according to multiple maximum sensing values recorded in the statistical interval (i.e. multiple sets of sensing values associated with multiple sensing matrixes).

For example, the processor 21 calculates a mean and a standard deviation of the multiple maximum sensing values (Step S53), and then adjusts the identification parameter according to the mean and the standard deviation (Step S55).

In one aspect, the processor 21 decreases the identification parameter according to the mean and K times of the standard deviation, e.g., calculating a first target parameter according to the mean and the K times of the standard deviation, and updating the identification parameter according to the first target parameter and the identification parameter. For example, the processor 21 firstly calculates a target parameter=the mean-the K times of the standard deviation. Next, when an original identification parameter is larger than the target parameter, the processor 21 calculates an updated identification parameter=the target parameter×R+the original identification parameter×(1−R), wherein R is between 0 and 1.

In one aspect, the processor 21 increases the identification parameter according to the mean and J times of the standard deviation, e.g., calculating a second target parameter according to the mean and the J times of the standard deviation, and updating the identification parameter according to the second target parameter and the identification parameter. For example, the processor 21 firstly calculates a target parameter =the mean-the J times of the standard deviation. Next, when an original identification parameter is smaller than the target parameter, the processor 21 calculates an updated identification parameter=the target parameter×R+the original identification parameter×(1−R), wherein R is between 0 and 1.

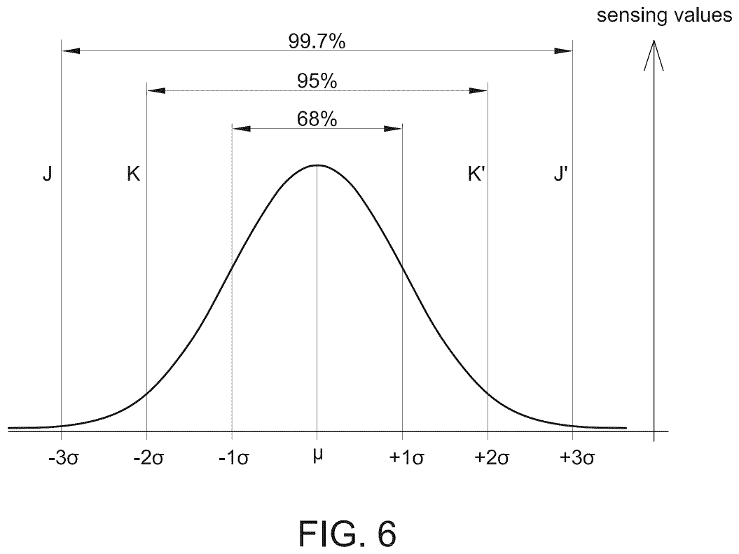

In one aspect, K and J values are selected according to statistical values of multiple sensing values (e.g., shown as a normal distribution, but not limited to) in FIG. 6. In one aspect, an absolute value of J is larger than that of K. For example, FIG. 6 shows J=−3 and K=−2.

In one aspect, the identification parameter includes a touch threshold (for identifying an object appearing on the touchpad 20) and a release threshold (for identifying an object leaving the touchpad 20). The processor 21 adjusts the touch threshold according to the multiple maximum sensing values, and adjusts the release threshold according to a ratio of the touch threshold and the release threshold before the adjustment. For example, a ratio before adjustment of original touch threshold/original release threshold=R1, then a ratio after adjustment of adjusted touch threshold/adjusted release threshold=R1. In another aspect, the processor 21 adjusts the release threshold using the same way as adjusting the touch threshold.

Similarly, in the second embodiment, the processor 21 is arranged not to record/use maximum sensing values of non-finger touch to prevent from using unsuitable data to update the identification parameter.

The touch sensing device 10 of the third embodiment of the present disclosure is used to adjust a finger recognition parameter, which is different from the first embodiment in that the finger recognition parameter in the third embodiment is a parameter to define a finger shape (or referred to length ratio parameter). The touch sensing device 10 in the third embodiment also includes the touchpad 20, the processor 21 and the memory 23 in FIG. 2, and the types thereof have been illustrated in the first embodiment only with different functions as described hereinafter.

The touchpad 20 is used to output a sensing matrix 400 including multiple sensing values as shown FIG. 4.

The memory 23 records a ratio parameter for identifying whether a finger touch occurs or not, wherein the ratio parameter indicates a ratio of a length (i.e. long-axis) and a width (i.e. short-axis) of a touched finger. When a ratio of the length and the width on the touchpad 20 exceeds the ratio parameter, the processor 21 identifies a non-finger, e.g., generating confidence bit=0.

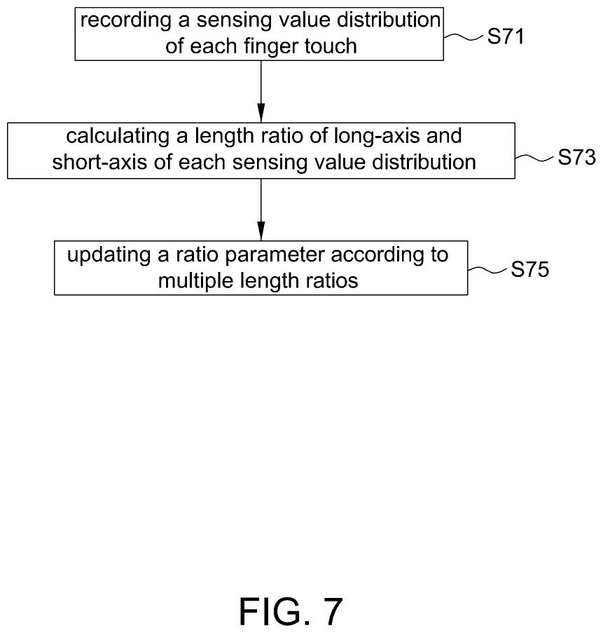

Please also refer to FIG. 7, it is a flow chart of an operating method of updating a finger recognition parameter of a touch sensing device 10 according to a third embodiment of the present disclosure. When the touchpad 20 is operated to a predetermined times (or accumulated operation time reaching a predetermined time interval) to determine a statistical interval, the processor 21 records a sensing value distribution of each finger touch within the statistical interval (Step S71), e.g., FIG. 4 showing one sensing value distribution. In this embodiment, the memory 23 further records an identification parameter for identifying whether an object touch occurs (as described in the second embodiment), and the identification parameter is used to determine the sensing value distribution. For example, the identification parameter is set as 100 sensing value, and the processor 21 identifies an object touch occurred to those values in FIG. 4 over 100. That is, only sensing values larger than 100 are included in the sensing value distribution. Then, the processor 21 recognizes whether the object with the sensing value distribution is a finger or not, e.g., according to the first parameter and/or the second parameter in the first embodiment and the ratio parameter in the third parameter. Similarly, the processor 21 is arranged not to record/process sensing value distributions of non-finger touch.

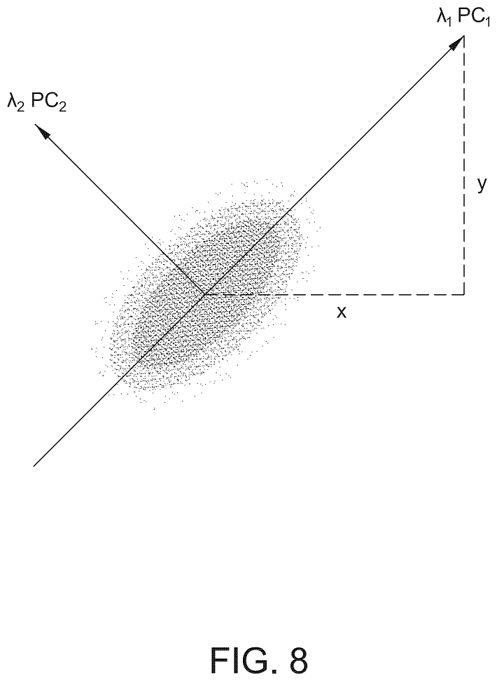

Step S73: Next, the processor 21 calculates multiple length ratios of long-axis and short-axis of multiple sensing value distributions (or called valid sensing value distributions indicating a finger touch) during the statistical interval, wherein the multiple sensing value distributions are obtained according to multiple sets of sensing values associated with multiple sensing matrixes received in a predetermined time interval. As mentioned above, non-finger sensing value distributions are considered as invalid sensing value distributions. In one aspect, the processor 21 calculates a covariance matrix according to a valid sensing value distribution and corresponding coordinates of every sensing value in the valid sensing value distribution, and calculates two Eigen vectors, perpendicular to each other, of the covariance matrix as the long-axis and the short-axis, e.g., λ1PC1 and λ2PC2 in FIG. 8. It should be mentioned that the method of calculating the long-axis and the short-axis is not limited to that mentioned herein, and the long-axis and the short-axis may be calculated using other known methods in the art without particular limitations.

Step S75: Finally, the processor 21 updates the ratio parameter according to the multiple length ratios.

In one aspect, the processor 21 calculates a mean and a standard deviation of the multiple length ratios of the multiple valid sensing value distributions recorded within the predetermined times, i.e. the statistical interval. The processor 21 increases the ratio parameter according to the mean and K′ times of the standard deviation, and decreases the ratio parameter according to the mean and J′ times of the standard deviation. In one aspect, an absolute value of the J′ is larger than that of K′. For example, FIG. 6 shows J′=3 and K′=2.

For example, the processor 21 updates the ratio parameter as a sum of the mean and the K′ times of the standard deviation upon the ratio parameter being smaller than the sum of the mean and the K′ times of the standard deviation.

For example, the processor 21 updates the ratio parameter as a sum of the mean and the J′ times of the standard deviation upon the ratio parameter being larger than the sum of the mean and the K′ times of the standard deviation.

The first embodiment to the third embodiment of the present disclosure may be combined to form new embodiments. For example, the processor uses different touch identification parameters respectively in the cold zone and the hot zone determined in the first embodiment, e.g., a relatively larger touch identification parameter being used in the cold zone and a relatively smaller touch identification parameter being used in the hot zone to avoid the mistaken touch in the code zone. For example, the processor uses different ratio parameters respectively in the cold zone and the hot zone determined in the first embodiment, e.g., a relatively smaller ratio parameter being used in the cold zone and a relatively larger ratio parameter being used in the hot zone to avoid the mistaken touch of a palm in the cold zone.

For example, the memory 23 records at least one of a sensing value parameter (e.g., second embodiment mentioned above), a length ratio parameter (e.g., third embodiment mentioned above) and a size parameter (e.g., first embodiment mentioned above) for identifying an object state. The processor 21 updates at least one of the sensing value parameter, the length ratio parameter and the size parameter according to multiple sets of sensing values associated with multiple sensing matrixes received in a predetermined time interval. The processor 21 further receives one set of sensing values (e.g., in one sensing matrix) containing touch information after the predetermined time interval, and identifies the object state, e.g., including a palm touch and a finger touch, according to a comparison result of the one set of sensing values and the at least one of the sensing value parameter, the length ratio parameter and the size parameter.

As mentioned above, the sensing value parameter, the length ratio parameter and the size parameter respectively includes a set of parameters associated with a first zone (e.g., 20hz) and a second zone (e.g., 20cz) corresponding to the touchpad 20. In one aspect, a first parameter corresponding to the first zone 20hz is a fixed parameter, and a second parameter corresponding to the second zone 20cz is a variable parameter.

It should be mentioned that although the touchpad in the above embodiments is described to be divided into two zones as an example, the present disclosure is not limited thereto. In other aspects, the touchpad may be divided into more than two zones and each zone uses a parameter, different from those of other zones, for distinguishing a finger and a palm. That is, the less operated zone is arranged to identify an object as a palm easily.

It should be mentioned that the variable parameters mentioned in the above embodiments are learned and updated after shipment of the touch sensing device according to actual operations of a user, and is continuously updated (without limiting a number of times of updating) according to the continuous use of the user.

It should be mentioned that although the touchpad is illustrated by a capacitive touchpad as an example, the present disclosure is not limited thereto. The present disclosure is also adaptable to other types of touchpad, e.g., an optical touchpad and a resistive touchpad. The method of outputting sensing values by different types of touchpad is known to the art and thus details thereof are not described herein.

It should be mentioned that although the present disclosure is described in the way that the touchpad is embedded in a notebook computer, the present disclosure is not limited thereto. In other aspects, the touchpad may be independent from the computer system or arranged at other positions/components of a computer system without particular limitations.

In the present disclosure, the object touch is referred to a touch of an object confirmed but the object is not yet recognized as a finger or a palm. The finger touch is referred to a touch of a finger, e.g., confirmed by the finger recognition parameter.

As mentioned above, because the conventional touchpad adopts only one set of parameters such that it is not able to adapt to the usage habit and the finger feature of different users. Accordingly, the present disclosure further provides a touch sensing device and an operating method thereof that use different finger recognition parameters respectively in a cold zone and a hot zone (e.g., FIGS. 2-3), a touch sensing device and an operating method thereof that update a touch identification parameter according to the statistical sensing values (e.g., FIG. 5) and a touch sensing device and an operating method thereof that update a finger recognition parameter according to the statistical finger shapes (e.g., FIGS. 7-8). The present disclosure is able to continuously update each parameter according to the usage habit and the operation feature of a user to avoid the mistaken touch by a palm and the touch miss.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A touch sensing device, comprising:
a touchpad, configured to output a sensing matrix comprising multiple sensing values;
a memory, configured to record a first pixel range of a first zone and a second pixel range of a second zone corresponding to the touchpad, a first parameter corresponding to the first zone and a second parameter corresponding to the second zone, wherein the first parameter is a fixed parameter and the second parameter is a variable parameter, and the recorded first zone and the recorded second zone are not changed within a statistical interval, which is determined according to a number of times of operations of the touchpad; and
a processor, configured to determine to use the first parameter or the second parameter according to whether a position of a first contact, which is detected during each operation of the touchpad, is in the first zone or the second zone.

2. The touch sensing device as claimed in claim 1, wherein the processor is further configured to
identify a region having a number of times of touching accumulated in the statistical interval higher than a predetermined threshold as the first zone, and
identify a region having a number of times of touching accumulated in the statistical interval lower than the predetermined threshold as the second zone.

3. The touch sensing device as claimed in claim 2, wherein
the first parameter and the second parameter are pixel sizes for distinguishing a finger and a palm, and
a value of the second parameter is smaller than a value of the first parameter.

4. The touch sensing device as claimed in claim 2, wherein the processor is configured to
divide the sensing matrix outputted by the touchpad into multiple pixel regions each having N×M pixels,
count, in the statistical interval, the number of times of touching of each pixel region among the multiple pixel regions, and
compare the number of times of touching of the each pixel region with the predetermined threshold to identify whether the each pixel region belongs to the first zone or the second zone.

5. The touch sensing device as claimed in claim 4, wherein the processor is further configured to
filter the multiple pixel regions containing the first zone and the second zone to cause separated first zones to connect to each other.

6. The touch sensing device as claimed in claim 2, wherein the processor is further configured to
record, in the statistical interval, multiple finger sizes appearing in the sensing matrix outputted by the touchpad,
calculate a mean and a standard deviation of the multiple finger sizes, and
update the second parameter according to the mean and the standard deviation.

7. The touch sensing device as claimed in claim 1, wherein
the fixed parameter is a default value determined before shipment, and
the variable parameter is updated continuously according to user operations.

8. A touch sensing device, comprising:
a touchpad, configured to output a sensing matrix comprising multiple sensing values;
a memory, configured to record a first pixel range of a first zone and a second pixel range of a second zone corresponding to the touchpad; and
a processor, configured to define the first zone and the second zone according to multiple sets of sensing values associated with multiple sensing matrixes received in a predetermined time interval,
wherein the recorded first zone and the recorded second zone are not changed within the predetermined time interval for receiving the multiple sensing matrixes.

9. The touch sensing device as claimed in claim 8, wherein the processor is configured to
determine whether multiple positions of the touchpad detect an object touch according to the multiple sets of sensing values, and
define the first zone and the second zone according to touch information of every position in the predetermined time interval.

10. The touch sensing device as claimed in claim 9, wherein each of the every position is a pixel region including multiple pixels.

11. The touch sensing device as claimed in claim 9, wherein the processor is further configured to
receive one set of sensing values containing the touch information after the predetermined time interval, and
identify an object state in the first zone or the second zone according to the one set of sensing values.

12. The touch sensing device as claimed in claim 11, wherein the object state comprises a palm touch and a finger touch.

13. The touch sensing device as claimed in claim 11, wherein the memory is further configured to record a first parameter corresponding to the first zone and a second parameter corresponding to the second zone determined in the predetermined time interval, and
the first parameter and the second parameter are configured to identify the object state.

14. The touch sensing device as claimed in claim 13, wherein the first parameter is different from the second parameter.

15. The touch sensing device as claimed in claim 13, wherein
the first parameter is a fixed parameter, and
the second parameter is a variable parameter.

16. A touch sensing device, comprising:
a touchpad, configured to output a sensing matrix comprising multiple sensing values;
a memory, configured to record at least one of a sensing value parameter, a length ratio parameter and a size parameter for identifying an object state; and
a processor, configured to
update at least one of the sensing value parameter, the length ratio parameter and the size parameter according to multiple sets of sensing values associated with multiple sensing matrixes received in a predetermined time interval,
receive one set of sensing values containing touch information after the predetermined time interval, and
identify the object state according to a comparison result of the one set of sensing values and the at least one of the sensing value parameter, the length ratio parameter and the size parameter.

17. (canceled)

18. The touch sensing device as claimed in claim 16, wherein the object state comprises a palm touch and a finger touch.

19. The touch sensing device as claimed in claim 16, wherein each of the at least one of the sensing value parameter, the length ratio parameter and the size parameter recorded in the memory comprises a first parameter associated with a first zone corresponding to the touchpad and a second parameter associated with a second zone corresponding to the touchpad.

20. The touch sensing device as claimed in claim 19, wherein
the first parameter corresponding to the first zone is a fixed parameter, and
the second parameter corresponding to the second zone is a variable parameter.

21. The touch sensing device as claimed in claim 1, wherein the number of times of operations of the touchpad comprises a number of times that the touchpad detects a finger touch, a number of times that the touchpad is activated and a number of times of valid data being recorded.
